(19) United States
(12) Patent Application Publication
(10) Pub. No.: US 2017/0363446 A1
(43) Pub. Date: Dec. 21, 2017

(54) CAPACITOR DETECTION SYSTEM AND PASSIVE-TYPE PIN-DIVERGING MODULE THEREOF

(71) Applicant: APAQ TECHNOLOGY CO., LTD., Miaoli County (TW)

(72) Inventors: KUO-CHEN HUANG, CHIAYI COUNTY (TW); MING-GOO CHIEN, TAICHUNG CITY (TW); MING-TSUNG LIANG, NEW TAIPEI CITY (TW)

(21) Appl. No.: 15/331,830

(22) Filed: Oct. 22, 2016

(30) Foreign Application Priority Data
Jun. 21, 2016 (TW) 105119369

(51) Int. Cl. G01D 5/24; H01G 13/00

(52) U.S. Cl. CPC G01D 5/24; H01G 13/00

(57) ABSTRACT

A capacitor detection system and a passive-type pin-diverging module thereof are disclosed. The passive-type pin-diverging module is applied to two conductive pins of a capacitor, including a base structure and a rotatable structure. The rotatable structure is rotatably disposed on the base structure, and the rotatable structure has a curved surface. The two conductive pins of the capacitor respectively pass through two through holes of a seat board, each conductive pin has a lateral contact surface, the two lateral contact surfaces concurrently slidably contact the curved surface so as to diverge the two conductive pins, and the seat board is held by the two diverged conductive pins so as to prevent the seat board from being separated from the capacitor. The friction resistance between the conductive pin and the rotatable structure is decreased due to the sliding contact between the lateral contact surface and the curved surface.

### BACKGROUND OF THE INVENTION

### 1. Field of the Invention

The instant disclosure relates to a detection system and a pin-diverging module thereof, and more particularly to a capacitor detection system and a passive-type pin-diverging module thereof.

### 2. Description of Related Art

The winding-type capacitor includes a capacitor core, a casing, and a sealing cover. The capacitor core has an anode foil coupled to an anode terminal, a cathode foil coupled to a cathode terminal, a separator, and an electrolyte layer. The anode foil, the cathode foil and the separator are rolled together. The separator is disposed between the anode foil and the cathode foil. The electrolyte layer is formed between the anode foil and the cathode foil. The casing has an opening for receiving the capacitor core. The sealing cover can be used to seal the casing, and the anode terminal and the cathode terminal can pass through a through hole of the sealing cover. A given space is provided between the sealing cover and the capacitor core. A stopper for securing the space is provided on at least one of the anode terminal and the cathode terminal. However, the leakage current (LC) of the winding capacitor is increased and a short circuit of the winding capacitor may occur after diverging two pins of the winding capacitor.

### SUMMARY OF THE INVENTION

One aspect of the instant disclosure relates to a capacitor detection system and a passive-type pin-diverging module thereof.

One of the embodiments of the instant disclosure provides a passive-type pin-diverging module applied to two conductive pins of a capacitor, comprising a base structure and a rotatable structure. The rotatable structure is rotatably disposed on the base structure, and the rotatable structure has a curved surface. The two conductive pins of the capacitor respectively pass through two through holes of a seat board, each conductive pin has a lateral contact surface, the two lateral contact surfaces of the two conductive pins of the capacitor concurrently slidably contact the curved surface of the rotatable structure so as to diverge the two conductive pins of the capacitor, and the seat board is held by the two diverged conductive pins so as to prevent the seat board from being separated from the capacitor. The friction resistance between the conductive pin and the rotatable structure is decreased due to the sliding contact between the lateral contact surface of the conductive pin and the curved surface of the rotatable structure.

Another one of the embodiments of the instant disclosure provides a capacitor detection system, comprising a pin-flattening module, a passive-type pin-diverging module, a pin-positioning module, and an electrical performance testing module. The pin-flattening module is used for flattening two conductive pins of a capacitor. The passive-type pin-diverging module is adjacent to the pin-flattening module, and the passive-type pin-diverging module comprising a base structure and a rotatable structure. The rotatable structure is rotatably disposed on the base structure. The rotatable structure has a curved surface, the two conductive pins of the capacitor respectively pass through two through holes of a seat board, each conductive pin has a lateral contact surface, the two lateral contact surfaces of the two conductive pins of the capacitor concurrently slidably contact the curved surface of the rotatable structure so as to diverge the two conductive pins of the capacitor, and the seat board is held by the two diverged conductive pins so as to prevent the seat board from being separated from the capacitor. The pin-positioning module is adjacent to the passive-type pin-diverging module for bending the two conductive pins and positioning the two conductive pins on the seat board. The electrical performance testing module is adjacent to the pin-positioning module for testing the electrical performance of the capacitor.

Yet another one of the embodiments of the instant disclosure provides a passive-type pin-diverging module, comprising a base structure and a rotatable structure. The rotatable structure is rotatably disposed on the base structure, and the rotatable structure has a curved surface. The two conductive pins of a capacitor respectively concurrently slidably contact the curved surface of the rotatable structure so as to diverge the two conductive pins of the capacitor, and a seat board is held by the two diverged conductive pins so as to prevent the seat board from being separated from the capacitor.

More particularly, the base structure includes a first base body and a second base body detachably connected to the first base body, the first base body has a first base seat and a first pivot seat disposed on the first base seat, the second base body has a second base seat detachably connected to the first base seat and a second pivot seat disposed on the second base seat, and the rotatable structure is pivotably disposed between the first pivot seat and the second pivot seat.

More particularly, the rotatable structure includes a pivot axle detachably connected between the first pivot seat and the second pivot seat and a pivot roller disposed between the first pivot seat and the second pivot seat and pivotably disposed around the pivot axle, wherein the curved surface is a circular surface of the pivot roller, and the two lateral contact surfaces of the two conductive pins of the capacitor concurrently slidably contact the circular surface of the pivot roller for diverging the two conductive pins so as to make the two conductive pins incline toward a bottom side of the seat board by a predetermined angle, wherein the friction resistance between the conductive pin and the pivot roller is decreased due to the sliding contact between the lateral contact surface of the conductive pin and the circular surface of the pivot roller.

More particularly, the rotatable structure includes a pivot axle detachably connected between the first pivot seat and the second pivot seat and a pivot ball disposed between the first pivot seat and the second pivot seat and pivotably disposed around the pivot axle, wherein the curved surface is a spherical surface of the pivot ball, and the two lateral contact surfaces of the two conductive pins of the capacitor concurrently slidably contact the spherical surface of the pivot ball for diverging the two conductive pins so as to make the two conductive pins incline toward a bottom side of the seat board by a predetermined angle, wherein the friction resistance between the conductive pin and the pivot ball is decreased due to the sliding contact between the lateral contact surface of the conductive pin and the spherical surface of the pivot ball.

More particularly, the capacitor detection system further comprises a heat-generating module disposed between the pin-positioning module and the electrical performance testing module, wherein the heat-generating module provides a predetermined heat source to the capacitor so as to release stresses in the capacitor.

Therefore, the two lateral contact surfaces of the two conductive pins of the capacitor can concurrently slidably contact the curved surface of the rotatable structure so as to diverge the two conductive pins P of the capacitor, so that the seat board can be held by the two diverged conductive pins so as to prevent the seat board from being separated from the capacitor. Please note, the friction resistance between the conductive pin and the rotatable structure can be decreased due to the sliding contact between the lateral contact surface of the conductive pin and the curved surface of the rotatable structure. More precisely, the friction resistance between the conductive pin and the rotatable structure is decreased, so that the reaction force applied to the two conductive pins and the capacitor due to the sliding contact between the lateral contact surface and the curved surface can be decreased (or the structural variation of a junction between the conductive pin and the capacitor can be decreased, and an outer force applied to an inner structure of the capacitor can be decreased). Therefore, the capacitor provided by the instant disclosure can avoid increasing leakage current (LC) and causing a short circuit.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a function block diagram of the capacitor detection system according to the first embodiment of the instant disclosure;

FIG. 2 shows a lateral, schematic view before flattening of the two conductive pins of the capacitor according to the first embodiment of the instant disclosure;

FIG. 3 shows a lateral, schematic view after flattening of the two conductive pins of the capacitor according to the first embodiment of the instant disclosure;

FIG. 4 shows a perspective, exploded, schematic view of the passive-type pin-diverging module of the capacitor detection system according to the first embodiment of the instant disclosure;

FIG. 5 shows a lateral, assembly, schematic view of the passive-type pin-diverging module of the capacitor detection system according to the first embodiment of the instant disclosure;

FIG. 6 shows a schematic view of diverging the two conductive pins of the capacitor by the passive-type pin-diverging module according to the first embodiment of the instant disclosure;

FIG. 7 shows a lateral, schematic view of the two conductive pins of the capacitor having been diverged according to the first embodiment of the instant disclosure;

FIG. 8 shows a lateral, schematic view of the two conductive pins of the capacitor having been bent and positioned on the seat board according to the first embodiment of the instant disclosure;

FIG. 9 shows a lateral, assembly, schematic view of the passive-type pin-diverging module of the capacitor detection system according to the second embodiment of the instant disclosure;

FIG. 10 shows a schematic view of diverging the two conductive pins of the capacitor by the passive-type pin-diverging module according to the second embodiment of the instant disclosure;

FIG. 11 shows a perspective, assembly, schematic view of the passive-type pin-diverging module of the capacitor detection system according to the third embodiment of the instant disclosure;

FIG. 12 shows a schematic view of diverging the two conductive pins of the capacitor by the passive-type pin-diverging module according to the third embodiment of the instant disclosure; and

FIG. 13 shows a function block diagram of the capacitor detection system according to the fourth embodiment of the instant disclosure.

### DETAILED DESCRIPTION OF THE PREFERRED EMBODIMENTS

Embodiments of a capacitor detection system and a passive-type pin-diverging module thereof according to the instant disclosure are described herein. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

### First Embodiment

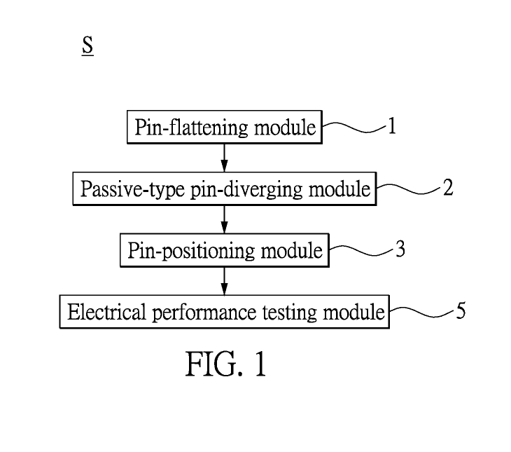

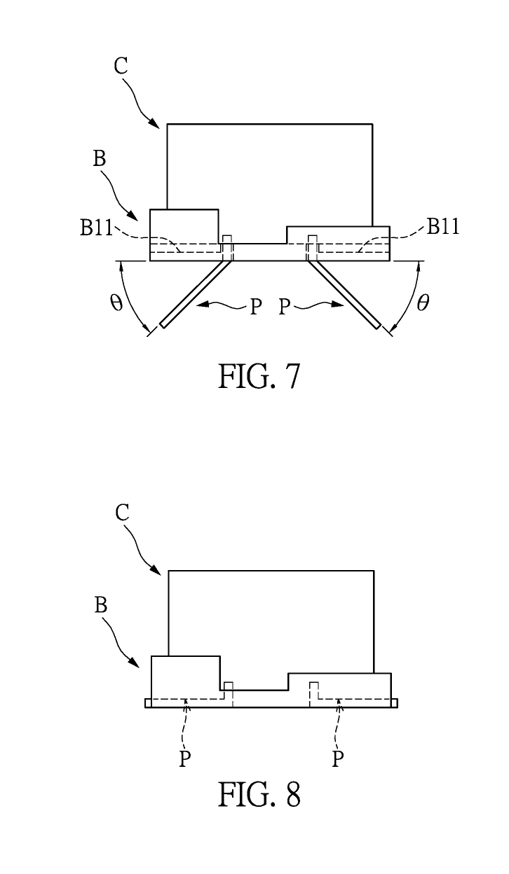

Referring to FIG. 1 to FIG. 8, the first embodiment of the instant disclosure provides a capacitor detection system S, comprising: a pin-flattening module 1, a passive-type pin-diverging module 2, a pin-positioning module 3, and an electrical performance testing module 5. The term passive-type means that the passive-type pin-diverging module 2 can passively contact two conductive pins P of a capacitor C so as to diverge, separate, or split the two conductive pins P of the capacitor C as shown in FIG. 7.

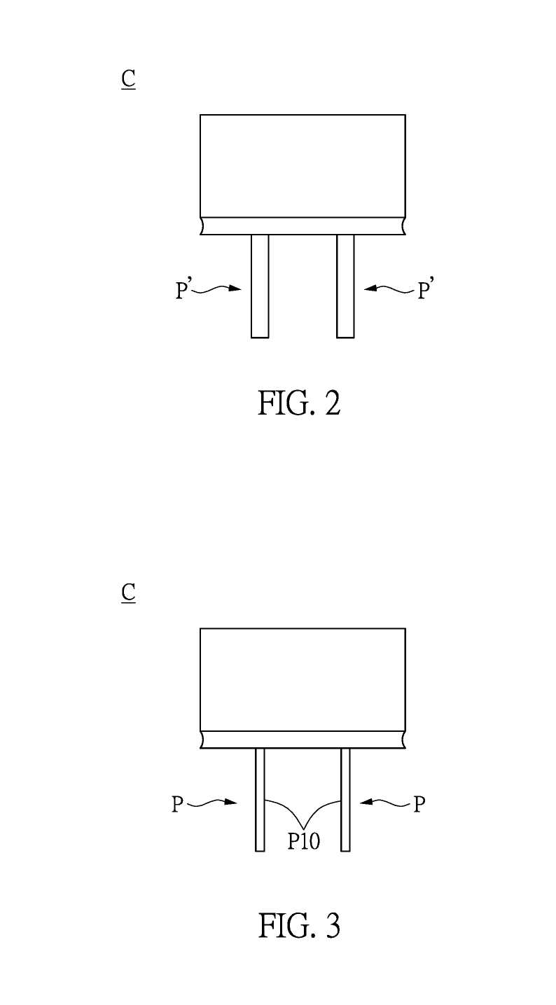

First, referring to FIG. 1 to FIG. 3, two cylindrical conductive pins P′ of the capacitor C can be flattened by the pin-flattening module 1 to form two flat-shaped conductive pins P. For example, the capacitor C may be a winding solid electrolytic capacitor, FIG. 2 shows a lateral, schematic view before flattening of the two conductive pins P of the capacitor C according to the instant disclosure, and FIG. 3 shows a lateral, schematic view after flattening of the two conductive pins P of the capacitor C according to the instant disclosure. In other words, the two cylindrical conductive pins P′ of the capacitor C can be flattened by the pin-flattening module 1, so that the shape of the conductive pin can be changed from cylindrical to flat. As shown in FIG. 3, after the cylindrical conductive pin P′ of the capacitor C is flattened by the pin-flattening module 1 to form the flat-shaped conductive pin P, a flattened lateral contact surface P10 is formed on an inner side of the flat-shaped conductive pin P.

Moreover, referring to FIG. 1 and FIG. 4 to FIG. 6, the passive-type pin-diverging module 2 is adjacent to the pin-flattening module 1 for diverging the two conductive pins P of the capacitor C, and the passive-type pin-diverging module 2 includes a base structure 20 and a rotatable structure 21. In addition, the rotatable structure 21 is rotatably disposed on the base structure 20, and the rotatable structure 21 has a curved surface 2100. For example, the curved surface 2100 may be a regular curved surface or an irregular curved surface.

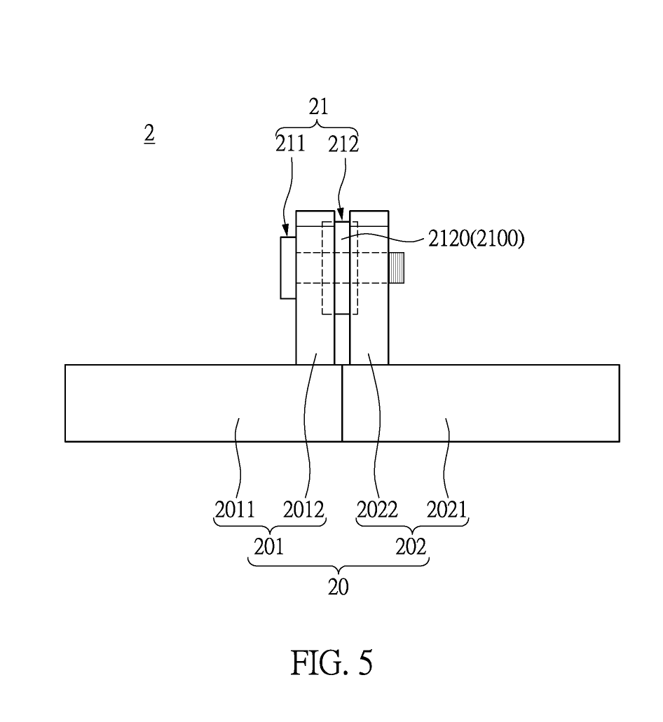

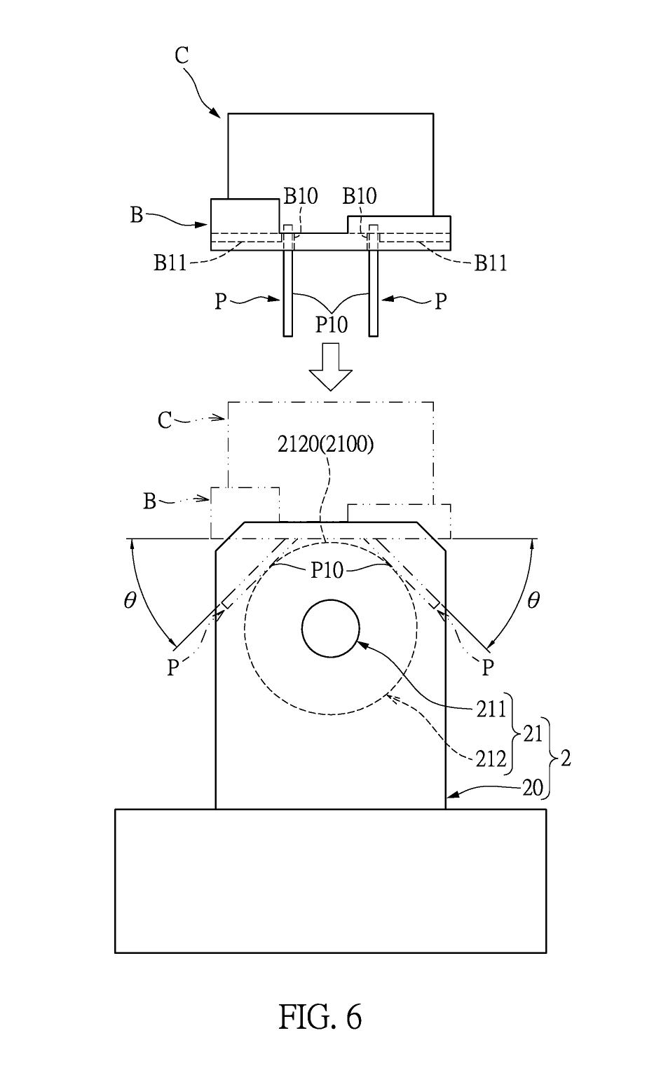

Therefore, referring to FIG. 5 and FIG. 6, the two conductive pins P of the capacitor C can respectively pass through two through holes B10 of a seat board B, and each conductive pin P has a lateral contact surface P10. The two lateral contact surfaces P10 of the two conductive pins P of the capacitor C can concurrently slidably contact the curved surface 2100 of the rotatable structure 21 so as to diverge the two conductive pins P of the capacitor C, so that the seat board B can be held by the two diverged conductive pins P so as to prevent the seat board B from being separated from the capacitor C. Please note, the friction resistance between the conductive pin P and the rotatable structure 21 can be decreased due to the sliding contact between the lateral contact surface P10 of the conductive pin P and the curved surface 2100 of the rotatable structure 21. More precisely, the friction resistance between the conductive pin P and the rotatable structure 21 is decreased, so that the reaction force applied to the two conductive pins P and the capacitor C due to the sliding contact between the lateral contact surface P10 and the curved surface 2100 can be decreased (or the structural variation of a junction between the conductive pin P and the capacitor C can be decreased, and an outer force applied to an inner structure of the capacitor C can be decreased). Therefore, the capacitor C provided by the instant disclosure can avoid increasing leakage current (LC) and causing a short circuit.

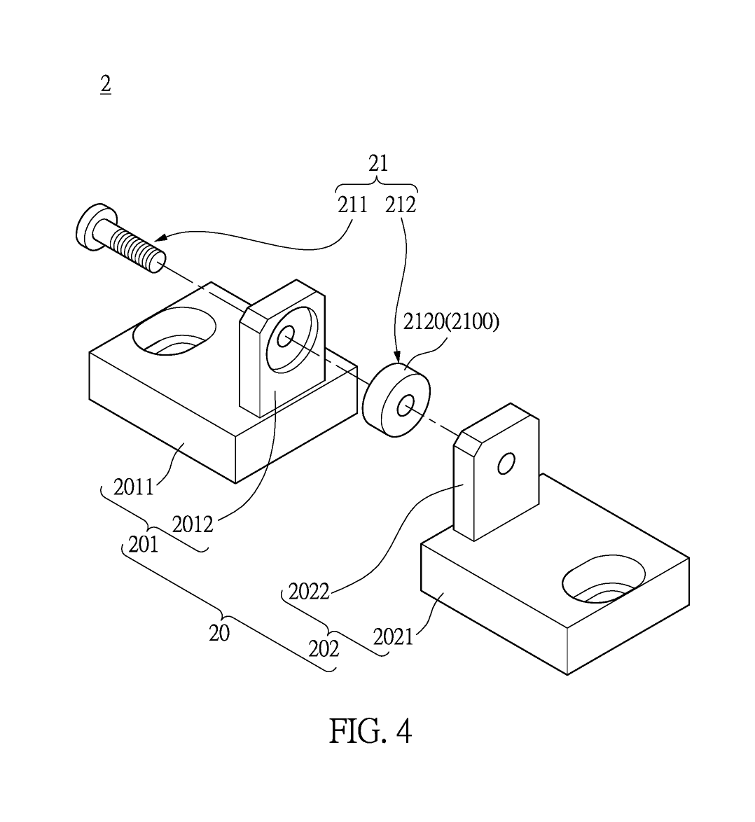

For example, referring to FIG. 4 to FIG. 6, the base structure 20 includes a first base body 201 and a second base body 202 detachably connected to the first base body 201. In addition, the first base body 201 has a first base seat 2011 and a first pivot seat 2012 vertically disposed on the first base seat 2011, the second base body 202 has a second base seat 2021 detachably connected to the first base seat 2011 and a second pivot seat 2022 vertically disposed on the second base seat 2021, and the rotatable structure 21 is pivotably disposed between the first pivot seat 2012 and the second pivot seat 2022.

Following the above description, the rotatable structure 21 includes a pivot axle 211 (such as a fixed axle or a ball-bearing axle) detachably connected between the first pivot seat 2012 and the second pivot seat 2022 and a pivot roller 212 (such as a general roller or a ball bearing) disposed between the first pivot seat 2012 and the second pivot seat 2022 and pivotably disposed around the pivot axle 211. In addition, the curved surface 2100 may be a circular surface 2120 of the pivot roller 212, and the two lateral contact surfaces P10 of the two conductive pins P of the capacitor C can concurrently slidably contact the circular surface 2120 of the pivot roller 212 for diverging the two conductive pins P so as to make the two conductive pins P incline toward a bottom side of the seat board B by a predetermined angle θ, so that the seat board B can be held by the two diverged conductive pins P so as to prevent the seat board B from being separated from the capacitor C. Please note, the friction resistance between the conductive pin P and the pivot roller 212 can be decreased due to the sliding contact between the lateral contact surface P10 of the conductive pin P and the circular surface 2120 of the pivot roller 212. More precisely, the friction resistance between the conductive pin P and the pivot roller 212 is decreased, so that the reaction force applied to the two conductive pins P and the capacitor C due to the sliding contact between the lateral contact surface P10 and the circular surface 2120 can be decreased (or the structural variation of a junction between the conductive pin P and the capacitor C can be decreased, and an outer force applied to an inner structure of the capacitor C can be decreased). Therefore, the capacitor C provided by the instant disclosure can avoid increasing leakage current (LC) and causing a short circuit.

Furthermore, referring to FIG. 1, FIG. 7, and FIG. 8, the pin-positioning module 3 is adjacent to the passive-type pin-diverging module 2 for bending the two conductive pins P and positioning the two conductive pins P on the seat board B. For example, the two conductive pins P can be positioned on two positioning grooves B11 of the seat board B. In addition, the electrical performance testing module 5 is adjacent to the pin-positioning module 3 for testing the electrical performance of the capacitor C. For example, the electrical performance testing module 5 can provide two testing pins (not shown) to electrically contact the two conductive pins P of the capacitor C so as to test the electrical performance of the capacitor C.

### Second Embodiment

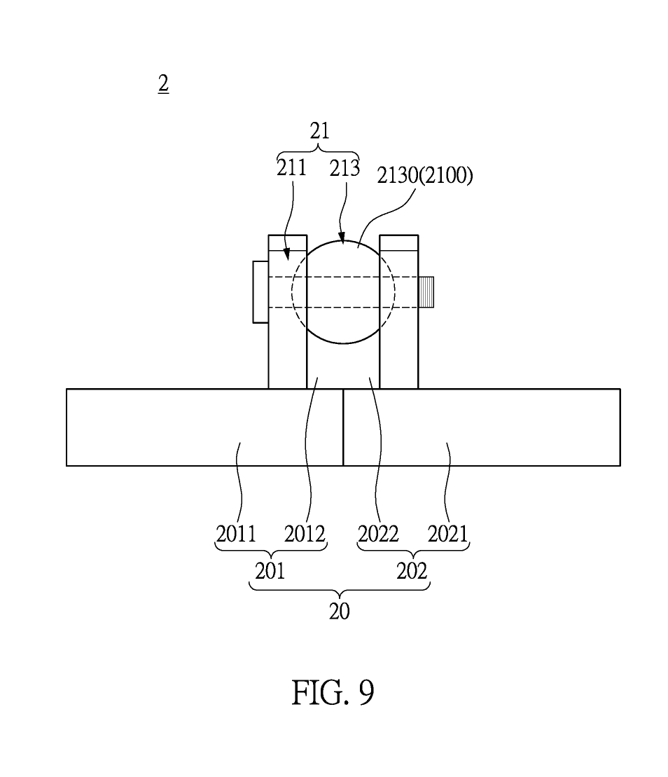

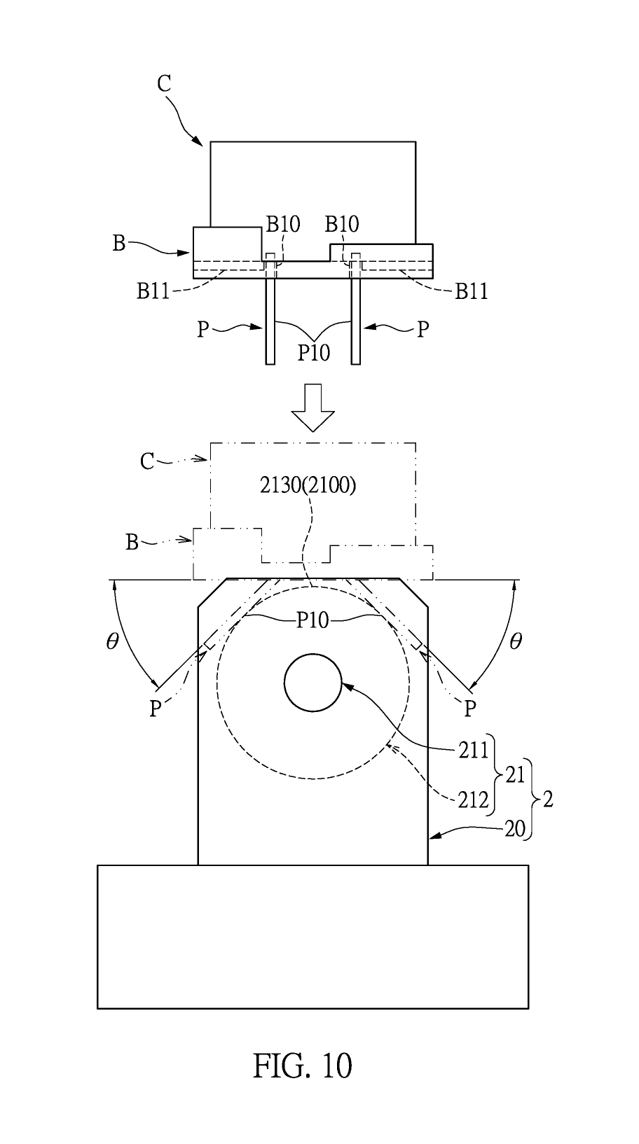

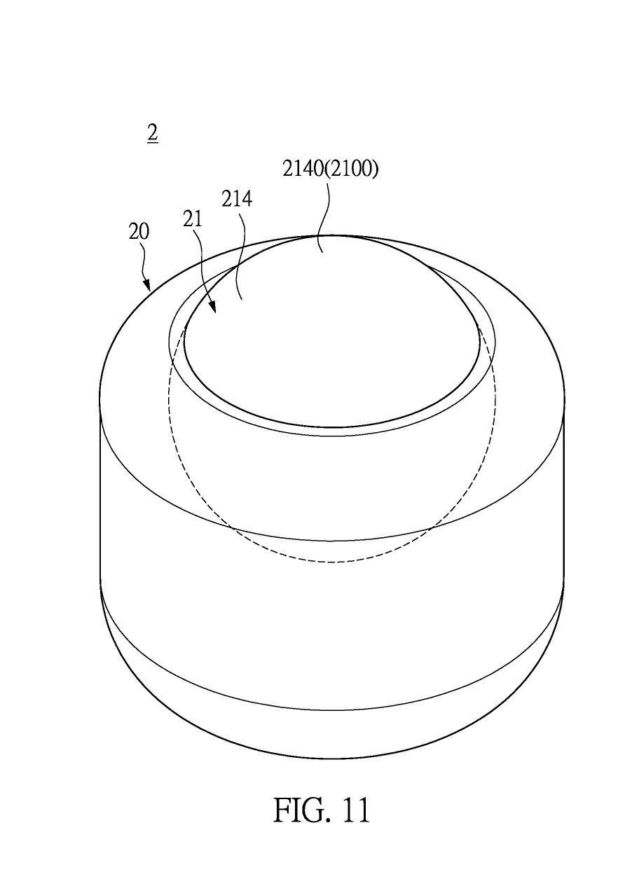

Referring to FIG. 9 and FIG. 10, the second embodiment of the instant disclosure provides a passive-type pin-diverging module 2 for diverging the two conductive pins P of the capacitor C, and the passive-type pin-diverging module 2 includes a base structure 20 and a rotatable structure 21. In addition, the rotatable structure 21 is rotatably disposed on the base structure 20, and the rotatable structure 21 has a curved surface 2100.

More particularly, the rotatable structure 21 includes a pivot axle 211 detachably connected between the first pivot seat 2012 and the second pivot seat 2022 and a pivot ball 213 disposed between the first pivot seat 2012 and the second pivot seat 2022 and pivotably disposed around the pivot axle 211. In addition, the curved surface 2100 may be a spherical surface 2130 of the pivot ball 213, and the two lateral contact surfaces P10 of the two conductive pins P of the capacitor C can concurrently slidably contact the spherical surface 2130 of the pivot ball 213 for diverging the two conductive pins P so as to make the two conductive pins P incline toward a bottom side of the seat board B by a predetermined angle θ, so that the seat board B can be held by the two diverged conductive pins P so as to prevent the seat board B from being separated from the capacitor C. Please note, the friction resistance between the conductive pin P and the pivot ball 213 can be decreased due to the sliding contact between the lateral contact surface P10 of the conductive pin P and the spherical surface 2130 of the pivot ball 213. More precisely, the friction resistance between the conductive pin P and the pivot ball 213 is decreased, so that the reaction force applied to the two conductive pins P and the capacitor C due to the sliding contact between the lateral contact surface P10 and the spherical surface 2130 can be decreased (or the structural variation of a junction between the conductive pin P and the capacitor C can be decreased, and an outer force applied to an inner structure of the capacitor C can be decreased). Therefore, the capacitor C provided by the instant disclosure can avoid increasing leakage current (LC) and causing a short circuit.

### Third Embodiment

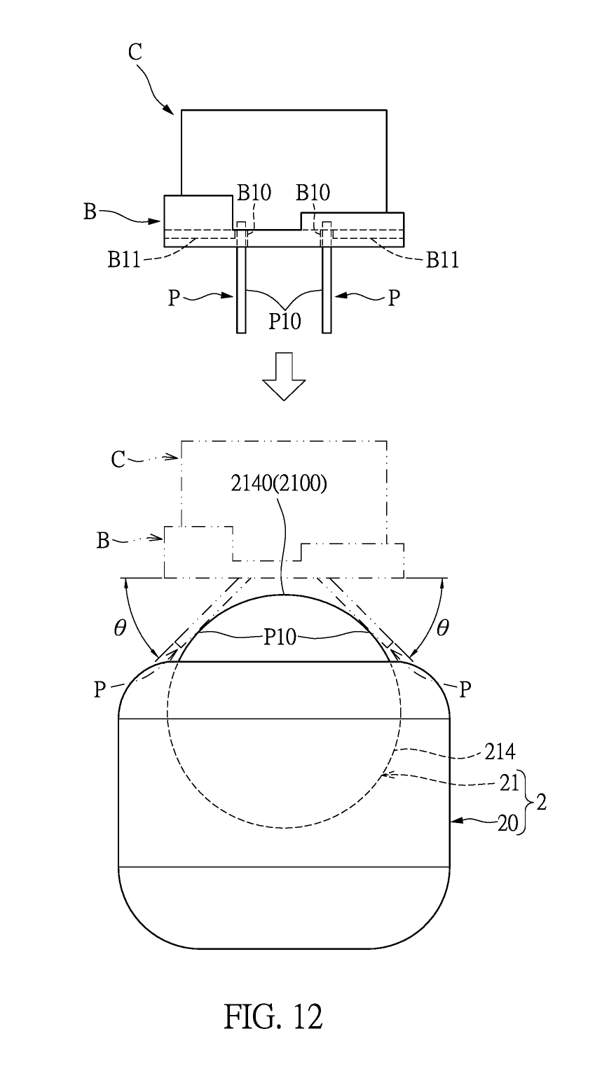

Referring to FIG. 11 and FIG. 12, the third embodiment of the instant disclosure provides a passive-type pin-diverging module 2 for diverging the two conductive pins P of the capacitor C, and the passive-type pin-diverging module 2 includes a base structure 20 and a rotatable structure 21. In addition, the rotatable structure 21 is rotatably disposed on the base structure 20, and the rotatable structure 21 has a curved surface 2100.

More particularly, the rotatable structure 21 includes a rotatable ball 214. In addition, the curved surface 2100 may be a spherical surface 2140 of the rotatable ball 214, and the two lateral contact surfaces P10 of the two conductive pins P of the capacitor C can concurrently slidably contact the spherical surface 2140 of the rotatable ball 214 for diverging the two conductive pins P so as to make the two conductive pins P incline toward a bottom side of the seat board B by a predetermined angle θ, so that the seat board B can be held by the two diverged conductive pins P so as to prevent the seat board B from being separated from the capacitor C. Please note, the friction resistance between the conductive pin P and the rotatable ball 214 can be decreased due to the sliding contact between the lateral contact surface P10 of the conductive pin P and the spherical surface 2140 of the rotatable ball 214. More precisely, the friction resistance between the conductive pin P and the rotatable ball 214 is decreased, so that the reaction force applied to the two conductive pins P and the capacitor C due to the sliding contact between the lateral contact surface P10 and the spherical surface 2140 can be decreased (or the structural variation of a junction between the conductive pin P and the capacitor C can be decreased, and an outer force applied to an inner structure of the capacitor C can be decreased). Therefore, the capacitor C provided by the instant disclosure can avoid increasing leakage current (LC) and causing a short circuit.

### Fourth Embodiment

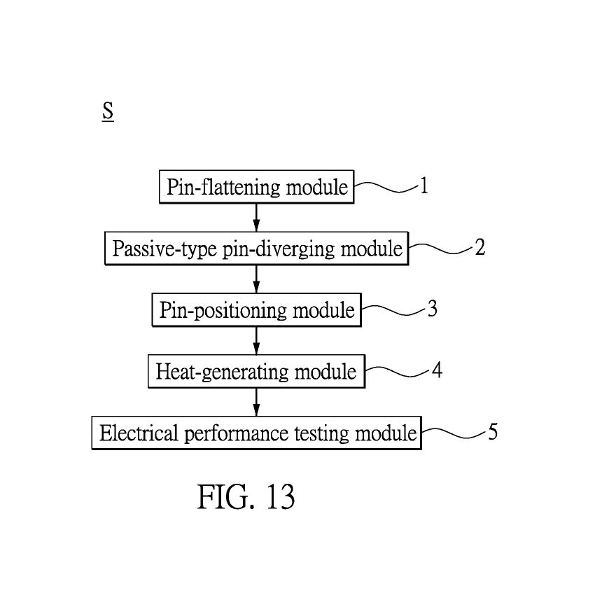

Referring to FIG. 13, the fourth embodiment of the instant disclosure provides a capacitor detection system S, comprising: a pin-flattening module 1, a passive-type pin-diverging module 2, a pin-positioning module 3, and an electrical performance testing module 5. Comparing FIG. 13 and FIG. 1, the difference between the fourth embodiment and the first embodiment is as follows: the fourth embodiment of the capacitor detection system S further comprises a heat-generating module 4 disposed between the pin-positioning module 3 and the electrical performance testing module 5, and the heat-generating module 4 can provide a predetermined heat source to the capacitor C so as to release stresses in the capacitor C. The stresses in the capacitor C are generated by the reaction force that is applied to the two conductive pins P and the capacitor C due to the sliding contact between the lateral contact surface P10 and the curved surface 2100. For example, the heat-generating module 4 may be a hot air generator, an infrared generator, or an ultraviolet generator for generating the predetermined heat source.

In conclusion, the two lateral contact surfaces P10 of the two conductive pins P of the capacitor C can concurrently slidably contact the curved surface 2100 of the rotatable structure 21 so as to diverge the two conductive pins P of the capacitor C, so that the seat board B can be held by the two diverged conductive pins P so as to prevent the seat board B from being separated from the capacitor C. Please note, the friction resistance between the conductive pin P and the rotatable structure 21 can be decreased due to the sliding contact between the lateral contact surface P10 of the conductive pin P and the curved surface 2100 of the rotatable structure 21. More precisely, the friction resistance between the conductive pin P and the rotatable structure 21 is decreased, so that the reaction force applied to the two conductive pins P and the capacitor C due to the sliding contact between the lateral contact surface P10 and the curved surface 2100 can be decreased (or the structural variation of a junction between the conductive pin P and the capacitor C can be decreased, and an outer force applied to an inner structure of the capacitor C can be decreased). Therefore, the capacitor C provided by the instant disclosure can avoid increasing leakage current (LC) and causing a short circuit.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A passive-type pin-diverging module applied to two conductive pins of a capacitor, comprising:
a base structure; and
a rotatable structure rotatably disposed on the base structure, wherein the rotatable structure has a curved surface;
wherein the two conductive pins of the capacitor respectively pass through two through holes of a seat board, each conductive pin has a lateral contact surface, the two lateral contact surfaces of the two conductive pins of the capacitor concurrently slidably contact the curved surface of the rotatable structure so as to diverge the two conductive pins of the capacitor, and the seat board is held by the two diverged conductive pins so as to prevent the seat board from being separated from the capacitor;
wherein the friction resistance between the conductive pin and the rotatable structure is decreased due to the sliding contact between the lateral contact surface of the conductive pin and the curved surface of the rotatable structure.

2. The passive-type pin-diverging module of claim 1, wherein the base structure includes a first base body and a second base body detachably connected to the first base body, the first base body has a first base seat and a first pivot seat disposed on the first base seat, the second base body has a second base seat detachably connected to the first base seat and a second pivot seat disposed on the second base seat, and the rotatable structure is pivotably disposed between the first pivot seat and the second pivot seat.

3. The passive-type pin-diverging module of claim 2, wherein the rotatable structure includes a pivot axle detachably connected between the first pivot seat and the second pivot seat and a pivot roller disposed between the first pivot seat and the second pivot seat and pivotably disposed around the pivot axle, wherein the curved surface is a circular surface of the pivot roller, and the two lateral contact surfaces of the two conductive pins of the capacitor concurrently slidably contact the circular surface of the pivot roller for diverging the two conductive pins so as to make the two conductive pins incline toward a bottom side of the seat board by a predetermined angle, wherein the friction resistance between the conductive pin and the pivot roller is decreased due to the sliding contact between the lateral contact surface of the conductive pin and the circular surface of the pivot roller.

4. The passive-type pin-diverging module of claim 2, wherein the rotatable structure includes a pivot axle detachably connected between the first pivot seat and the second pivot seat and a pivot ball disposed between the first pivot seat and the second pivot seat and pivotably disposed around the pivot axle, wherein the curved surface is a spherical surface of the pivot ball, and the two lateral contact surfaces of the two conductive pins of the capacitor concurrently slidably contact the spherical surface of the pivot ball for diverging the two conductive pins so as to make the two conductive pins incline toward a bottom side of the seat board by a predetermined angle, wherein the friction resistance between the conductive pin and the pivot ball is decreased due to the sliding contact between the lateral contact surface of the conductive pin and the spherical surface of the pivot ball.

5. A capacitor detection system, comprising:
a pin-flattening module for flattening two conductive pins of a capacitor;
a passive-type pin-diverging module adjacent to the pin-flattening module, the passive-type pin-diverging module comprising:
a base structure; and
a rotatable structure rotatably disposed on the base structure, wherein the rotatable structure has a curved surface, the two conductive pins of the capacitor respectively pass through two through holes of a seat board, each conductive pin has a lateral contact surface, the two lateral contact surfaces of the two conductive pins of the capacitor concurrently slidably contact the curved surface of the rotatable structure so as to diverge the two conductive pins of the capacitor, and the seat board is held by the two diverged conductive pins so as to prevent the seat board from being separated from the capacitor;
a pin-positioning module adjacent to the passive-type pin-diverging module for bending the two conductive pins and positioning the two conductive pins on the seat board; and
an electrical performance testing module adjacent to the pin-positioning module for testing the electrical performance of the capacitor.

6. The capacitor detection system of claim 5, wherein the base structure includes a first base body and a second base body detachably connected to the first base body, the first base body has a first base seat and a first pivot seat disposed on the first base seat, the second base body has a second base seat detachably connected to the first base seat and a second pivot seat disposed on the second base seat, and the rotatable structure is pivotably disposed between the first pivot seat and the second pivot seat.

7. The capacitor detection system of claim 6, wherein the rotatable structure includes a pivot axle detachably connected between the first pivot seat and the second pivot seat and a pivot roller disposed between the first pivot seat and the second pivot seat and pivotably disposed around the pivot axle, wherein the curved surface is a circular surface of the pivot roller, and the two lateral contact surfaces of the two conductive pins of the capacitor concurrently slidably contact the circular surface of the pivot roller for diverging the two conductive pins so as to make the two conductive pins incline toward a bottom side of the seat board by a predetermined angle, wherein the friction resistance between the conductive pin and the pivot roller is decreased due to the sliding contact between the lateral contact surface of the conductive pin and the circular surface of the pivot roller.

8. The capacitor detection system of claim 6, wherein the rotatable structure includes a pivot axle detachably connected between the first pivot seat and the second pivot seat and a pivot ball disposed between the first pivot seat and the second pivot seat and pivotably disposed around the pivot axle, wherein the curved surface is a spherical surface of the pivot ball, and the two lateral contact surfaces of the two conductive pins of the capacitor concurrently slidably contact the spherical surface of the pivot ball for diverging the two conductive pins so as to make the two conductive pins incline toward a bottom side of the seat board by a predetermined angle, wherein the friction resistance between the conductive pin and the pivot ball is decreased due to the sliding contact between the lateral contact surface of the conductive pin and the spherical surface of the pivot ball.

9. The capacitor detection system of claim 6, further comprising: a heat-generating module disposed between the pin-positioning module and the electrical performance testing module, wherein the heat-generating module provides a predetermined heat source to the capacitor so as to release stresses in the capacitor.

10. A passive-type pin-diverging module, comprising:
a base structure; and
a rotatable structure rotatably disposed on the base structure, wherein the rotatable structure has a curved surface;
wherein two conductive pins of a capacitor respectively concurrently slidably contact the curved surface of the rotatable structure so as to diverge the two conductive pins of the capacitor, and a seat board is held by the two diverged conductive pins so as to prevent the seat board from being separated from the capacitor.
